(19) United States
(12) Patent Application Publication
(10) Pub. No.: US 2008/0291051 A1
(43) Pub. Date: Nov. 27, 2008

(54) RELAY WARNING SYSTEM FOR A MOTOR VEHICLE

(76) Inventor: William J. Hyslop, Coatesville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/126,404

(22) Filed: May 23, 2008

Related U.S. Application Data
(60) Provisional application No. 60/931,429, filed on May 23, 2007.

(51) Int. Cl. G08G 1/00

(52) U.S. Cl. 340/902

(57) ABSTRACT

A transmitter-receiver combination wherein the transmitter is mounted in a lead vehicle and the receiver is mounted in a following vehicle. Warning lights associated with the receiver are illuminated when the lead vehicle signals a turn or applies the brakes.

### CROSS REFERENCES TO RELATED APPLICATIONS

The present application claims the benefit of U.S. Provisional Patent Application Ser. No. 60/931,429, filed May 23, 2007, entitled “RELAY WARNING SYSTEM FOR A MOTOR VEHICLE” which is hereby incorporated by reference in its entirety.

### BACKGROUND OF THE INVENTION

When a vehicle (the reference vehicle) is following another vehicle, whether a car, truck or an SUV, in a line of traffic, it is usually not possible to see the turn signals or the brake lights of the vehicles that are two or three positions ahead of the reference vehicle. In which case, if for example the lead vehicle stops suddenly, the first and second following vehicles that are ahead of the reference vehicle each have a decreasing amount of time in which to stop. This could cause a rear end collision if the driver of the reference vehicle cannot react in time to stop, change lanes, or drive onto the shoulder of the road.

One solution to this problem is provided by the disclosed device of the present invention. The disclosed device is a transmitter and receiver arrangement. The concept is to have one or more of the vehicles that are three to four, or more, positions ahead of the reference vehicle be capable of sending a narrowly directed signal rearward. This transmitted signal provides either a visual signal or an audio signal or both as an indication that the corresponding lead vehicle is going to be making a turn, slowing down, or coming to a complete stop. This particular capability is accomplished by configuring these lead vehicles with a transmitter connected or integrated into the electrical system and corresponding or responding to the turn signals circuitry and/or brake light systems and circuitry. When, for example, a turn signal of the lead vehicle is activated, the disclosed system transmits a signal that lights the right or left turn signal light on a dash-mounted receiver on the reference vehicle. When the brakes of a lead vehicle are applied, the transmitter sends a signal to the reference vehicle that illuminates a center brake light on the dash. An audio signal can also be used as the warning or a combination of audio and visual. This early warning system alerts the driver of the reference vehicle, allowing the driver to slow the vehicle and allows the driver to be prepared to come to a complete stop, if necessary. The transmitter frequency is selected so that the transmit signal will be narrow and directional. This minimizes the interference from adjacent vehicles approaching from the side or from the opposite direction. This early warning system, according to the present invention and the disclosed device, will help prevent multiple vehicle pile ups that occur in fog or white-out driving conditions, for example. The disclosed device also provides added safety while driving during normal driving conditions.

### BRIEF SUMMARY

A transmitter-receiver combination wherein the transmitter is mounted in a lead vehicle and the receiver is mounted in a following vehicle. Warning signals (lights and/or audio) associated with the receiver are generated when the lead vehicle signals a turn or applies the brakes.

One object of the present disclosure is to describe a transmitter-receiver system for motor vehicles.

### BRIEF DESCRIPTION OF THE SEVERAL VIEWS OF THE DRAWINGS

FIG. 1 is a diagrammatic illustration of a transmitter-receiver system for motor vehicles according to the present invention.

FIG. 2 is a schematic diagram of the transmitter circuitry of the FIG. 1 system according to one embodiment.

FIG. 3 is a schematic diagram of the receiver circuitry of the FIG. 1 system according to one embodiment.

FIG. 4 is a schematic diagram of the transmitter circuitry according to a further embodiment.

FIG. 5 is a schematic diagram of the receiver circuitry according to a further embodiment.

FIG. 6 is a flow diagram of the display options for the receiver circuit signal.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

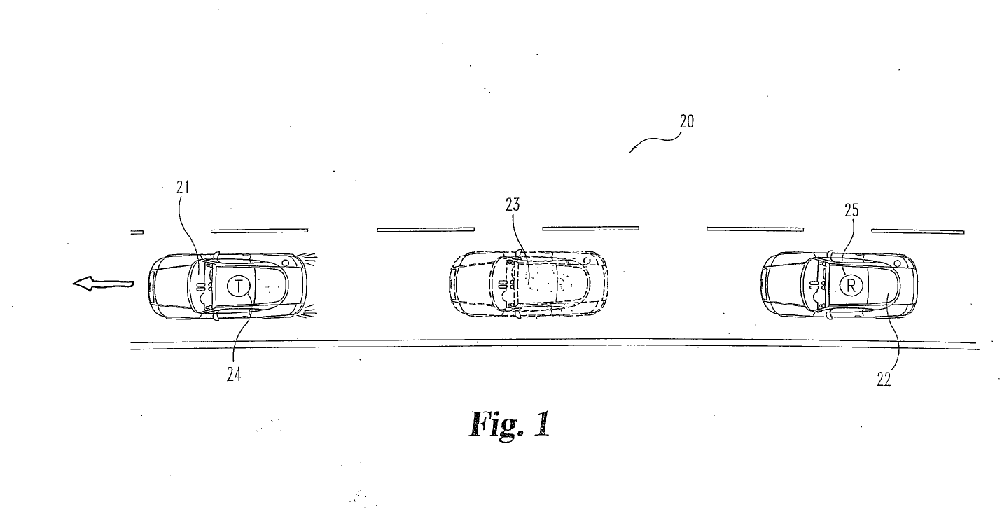

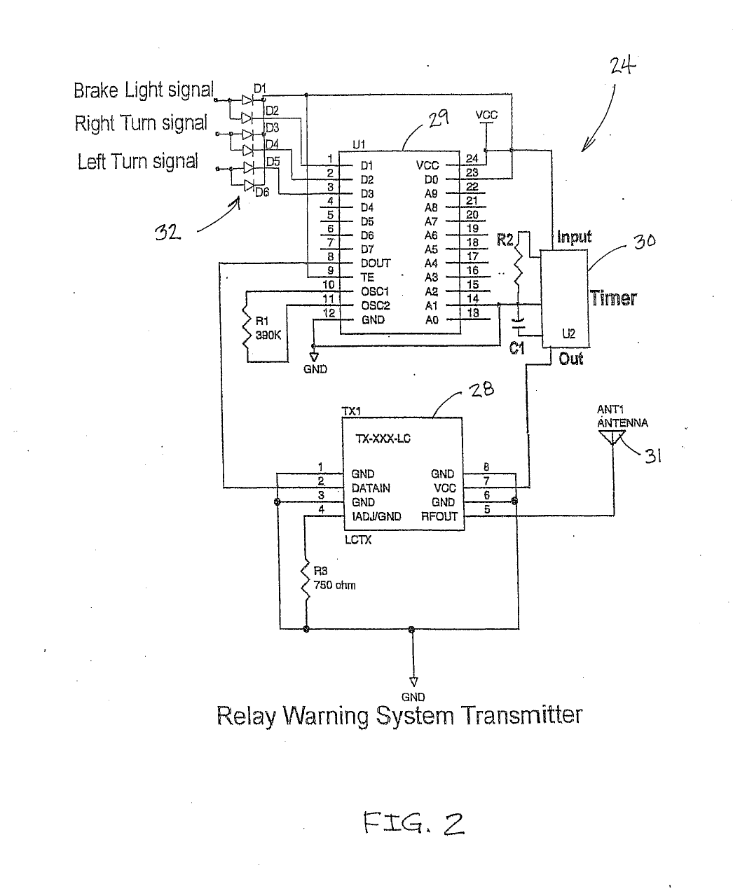

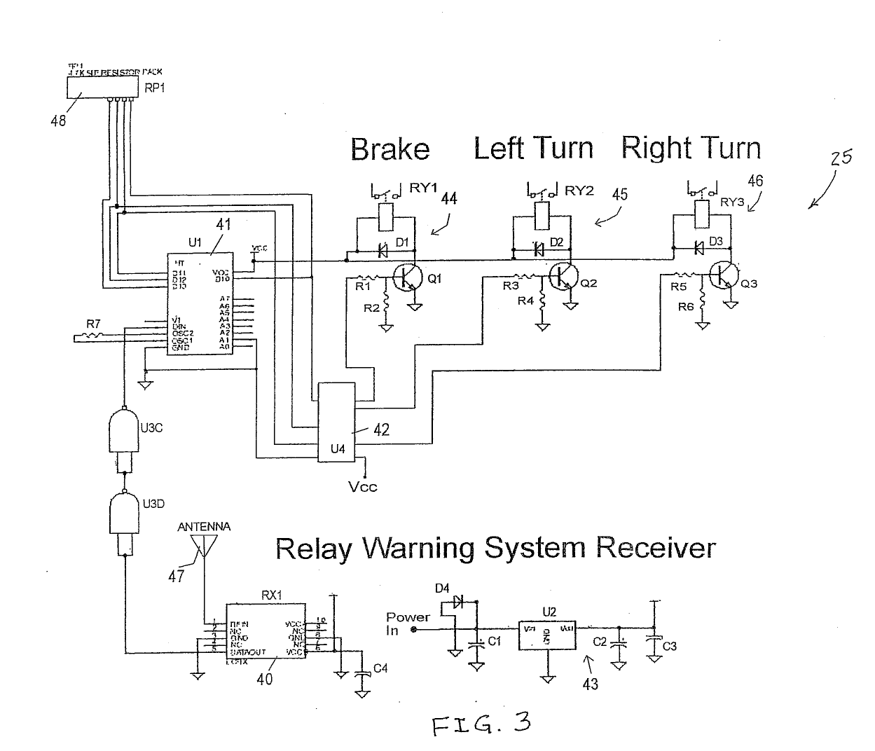

Referring to FIG. 1, there is illustrated (diagrammatically) a line of vehicles 20 in traffic including a lead vehicle 21, a reference vehicle 22, and one or more intermediate vehicles 23. The intermediate vehicle 23 is shown in broken line form to represent a variable number of vehicles positioned between vehicle 21 and vehicle 22. The lead vehicle 21 includes a transmitter 24 (see FIG. 2) electrically integrated into the braking system and into the turn signal system of lead vehicle 21. The reference vehicle 22 includes a receiver 25 (see FIG. 3) electrically integrated into the reference vehicle 22 with a display of one or more warning indicators, preferably lights and preferably dash mounted in some fashion. Instead of lights, audible alarms can be used as warning indicators, and a combination of lights and audible alarms can be used. As used herein, “relay warning system” is defined to include, but is not limited to, a transmitter, a receiver, warning indicator(s), and the associated circuitry.

Referring to FIG. 2, the schematic diagram for the transmitter 24 is illustrated. The transmitter 24 portion of the relay warning system consists of the following major components:
1. An RF transmitter module 28 which produces a radio frequency signal whenever power and a data signal is applied to it;
2. An encoder 29 which produces a series of pulses (the data signal) that can be applied to the transmitter module;
3. A timer 30 which is used to cause the transmitter module to only produce a periodic output signal;
4. An antenna 31 tuned to the radio frequency produced by the transmitter module 28; and
5. A power switching arrangement 32 consisting of up to six (6) diodes (D1 to D6).

The schematic (see FIG. 2) of the transmitter 24 shows one method of accomplishing the needed results. In a simple implementation, only the brake lights would be connected. In this implementation, the turn signal connections will not be used. When a driver applies the brakes, power is connected to the encoder 29 and the timer 30. The encoder 29 produces pulses whenever power is applied. These pulses are applied to the data input of the transmitter module 28. The timer 30 will periodically apply then interrupt power to the transmitter module. This prevents the transmitter 24 from constantly producing an output. If the transmitter were allowed to produce a constant output, it could cause interference to some relay warning system receivers, causing them to give erroneous output signals to the driver. A constant signal could also cause interference, causing a problem obtaining FCC and other agency approvals. Resistor R1 is used to determine the period of the data pulses. Resistor R2 and capacitor C1 are used to determine the on/off timing of the transmitter circuit. Resistor R3 sets the power of the radio frequency signal being transmitted. The output of the transmitter module 28 is connected to the transmitter antenna 31. The antenna is suitable to be enclosed and to be mounted in or to the vehicle.

A more complex implementation would allow unique signals to be transmitted when the right and left turn signals are used as well as the brake signal. The right turn signal is connected through diodes D3 and D4. Power is connected through D3 to the encoder 29 and the timer 30. D4 connects power to a data input of the encoder 29, causing a unique set of data pulses associated with right turn. The encoder and timer circuits operate as described earlier. The left turn signal is connected through diodes D5 and D6. Power is connected through D6 to the encoder 29 and the timer 30. D5 connects power to a data input of the encoder circuit, causing a unique set of data pulses associated with left turn. The encoder and timer circuits operate as described earlier. The brake signal is connected through diodes D1 and D2. Power is connected through D1 to the encoder 29 and the timer 30. D2 connects power to a data input of the encoder 29, causing a unique set of data pulses associated with brake signal. The encoder and timer circuits operate as described earlier.

The brake, right turn, and left turn signal signals can be wired into the portion of the vehicle wiring which lights the individual indicators on the vehicle, or more preferably they would be connected to signals from the vehicle's on-board computer system. The latter would minimize any interference which could be caused by other signals within the vehicle.

Table I provides component information regarding the electrical components that are illustrated and identified in the FIG. 2 transmitter 24 schematic.

TABLE I

| Component | Additional |
|---|---|
| Symbol | Information |
| U1 | HOLTEK HT 12 E IC |
| TX 1 | LINX TX 418 RC |
| U2 | IC LM 555 |
| D1-D6 | 1N4148 |
| R1 | 390K Ohms |
| R2 | 270K Ohms |
| R3 | 750 Ohms |
| C1 | 0.1 μF |

Referring to FIG. 3, the schematic diagram for the receiver 25 is illustrated. The receiver 25 portion of the relay warning system consists of the following major components:
1. An RF receiver module 40 which converts the radio frequency signal into a series of pulses to be applied to the decoder 41;
2. A decoder 41 which receives a series of pulses from the RF receiver module 40 (the data signal) that are used to warn a driver of the intentions of a driver in another upfront vehicle;
3. A microcontroller 42 which is used to keep the various signals from the decoder from interfering with each other;
4. A power conditioning circuit 43;
5. Interface circuits 44, 45 and 46(up to three (3) circuits) to supply power to indicators located where a driver can easily see them; and
6. An antenna 47 tuned to the radio frequency to be received by the receiver circuit 25.

A signal that is transmitted from a nearby (upfront) vehicle is applied to a receiving antenna 47 and then to a receiver module 40 (RX1). The receiver module is tuned to the same frequency as the transmitter located in another vehicle. The output of the receiver module 40 is connected to a decoder 41 (U1). There may be a buffer/signal conditioning circuit, as indicated on the schematic as U3C and U3D. R7 is used to set the period of the data pulses. A resistor pack 48 (RP1) consisting of a resistor for each data line used is connected to each data output. The output signals of the decoder 41 are connected to a microcontroller 42. The microcontroller is used to ensure the driver gets the best information about what other vehicles may do. The brake signal may take priority over turn signals. When these signals are received and decoded, they are applied to the interface circuits 44-46. These circuits may have relays or other devices as may be appropriate for the warning indicators that may be used within the vehicle.

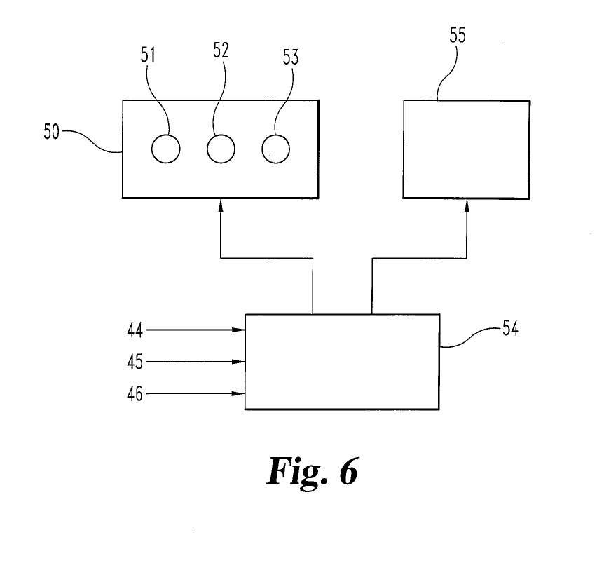

In the preferred embodiment, a small display panel 50 is incorporated into the dashboard area of the vehicle (see FIG. 6). The three lights 51, 52 and 53 correspond to a left turn signal, applying the brakes and a right turn signal, respectively. The display panel 50 is electrically connected to the three interface circuits 44, 45 and 46 by appropriate gate circuitry 54.

Table II provides component information regarding the electrical components that are illustrated and identified in the FIG. 3 receiver 25 schematic.

TABLE II

| Component | Additional |
|---|---|
| Symbol | Information |
| U1 | HOLTEK HT 12D |
| U2 | LM 7805 IC |
| U3 | 74 HC00 IC |
| U4 | Microcontroller |
| RX1 | LINX RX 418 RC |
| Q1-Q3 | 2N 3904 or 2N 2222 |
| RY1-RY3 | TX2-5V OMRON relay |
| D1-D3 | 1N 4148 |
| R1, R3, R5 | 680 Ohms |
| R2, R4, R6 | 10K Ohms |
| R7 | 390K Ohms |
| C1 | 1000 μf |
| C2 | 100 μf |
| C3 | 0.1 μf |
| C4 | 0.01 μf |
| RP1 | 47K resistor pack |

In a simple implementation, only the brake light signal may be decoded. This would only require the brake interface circuit 44 (Q1, R1, R2, RY1 and diode D1), and would not use the connections to the microcontroller 42 for the right turn interface circuit 46 and left turn interface circuit 45 signals. Power is applied to all of the circuits from the power conditioning circuit including U2, D4, C1, C2 and C3.

The brake interface circuit 44 output may also be connected either to the vehicle's on board computer or through another acceptable means to light the brake lights on the vehicle that has the receiver. This allows a driver directly in back of this vehicle (even though they do not have a relay warning system installed) to know someone just ahead is stopping. This option of lighting the brake lights on the vehicle with the receiver could also be performed in response to a turn signal from interface circuits 45 and 46. FIG. 6 diagrammatically illustrates the vehicle brake lights by block 55. The logic gate circuitry is programmed and arranged to enable the system to light up the display panel lights 51-53, the vehicle brake lights 55, or both.

The frequency is selected so that the transmit signal is narrow and directional. This minimizes the interference from adjacent vehicles approaching from the opposite direction. The frequency is envisioned to be above 2 GHz. Additionally, the frequency selected will be transparent to a typical motor vehicle. Such a frequency will ensure that the transmitted signal will not be reflected by any intermediate vehicles positioned between the transmitter 24 and receiver 25.

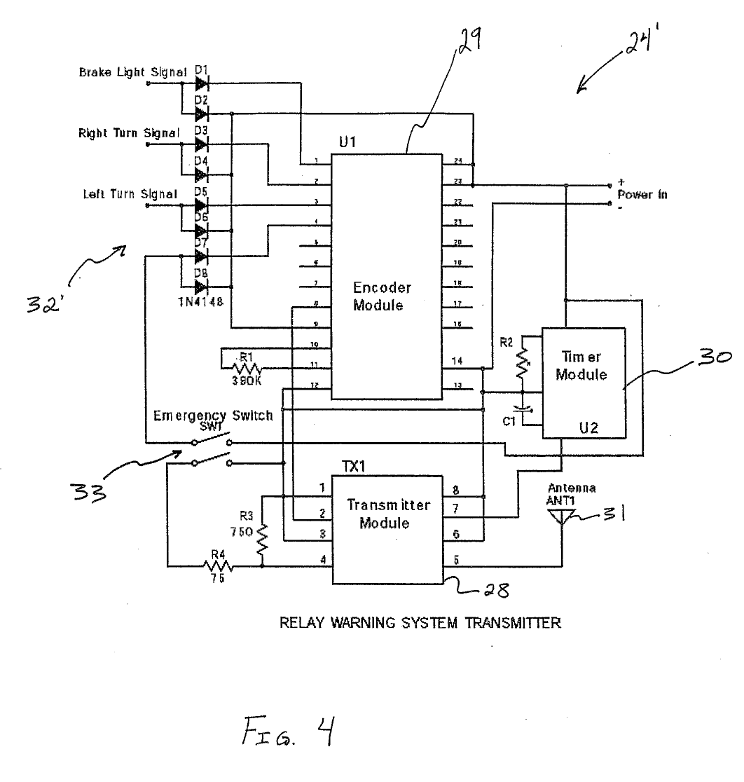

Referring to now to FIG. 4, the schematic diagram for a transmitter 24′ according to another embodiment is illustrated. Transmitter 24′ is similar to transmitter 24 in terms of the components and circuitry. However, in this embodiment, an emergency switch 33 is provided. As discussed below, emergency switch 33 allows for a stronger signal to be transmitted by transmitter 24′. In one embodiment, the signal may travel up to a distance of ¾ of a mile. Those skilled in the art will appreciate that such an option would be beneficial in conditions of very low visibility, such as a white-out. In addition to the major components of transmitter 24, transmitter 24′ has two (2) additional diodes D7, D8 as well as the manually operated emergency switch 33.

The transmission of a signal by transmitter 24′ is substantially the same as that described hereinabove for transmitter 24. In this embodiment, resistor R4 sets the increased power output for emergency switch 33. Further, power is connected through D8 to the encoder 29 and the timer 30. D7 connects the power to a data input of the encoder 29, causing a unique set of data pulses associated with the emergency switch 33.

The brake, right turn, and left turn signal signals can be wired into the portion of the vehicle wiring which lights the individual indicators on the vehicle, or more preferably they are connected to signals from the vehicle's on-board computer system. The latter minimizes any interference which could be caused by other signals within the vehicle. In this embodiment, emergency switch 33 is an additional input.

Table III provides component information regarding the electrical components that are illustrated and identified in the FIG. 4 transmitter 24′ schematic.

TABLE III

| Component | Additional |
|---|---|
| Symbol | Information |
| U1 | HOLTEK HT 12 E IC |
| TX 1 | LINX TX 418 RC |
| U2 | IC LM 555 |
| D1-D8 | 1N4148 |
| R1 | 390K Ohms |
| R2 | 270K Ohms |
| R3 | 750 Ohms |
| R4 | 75 Ohms |
| C1 | 0.1 μF |

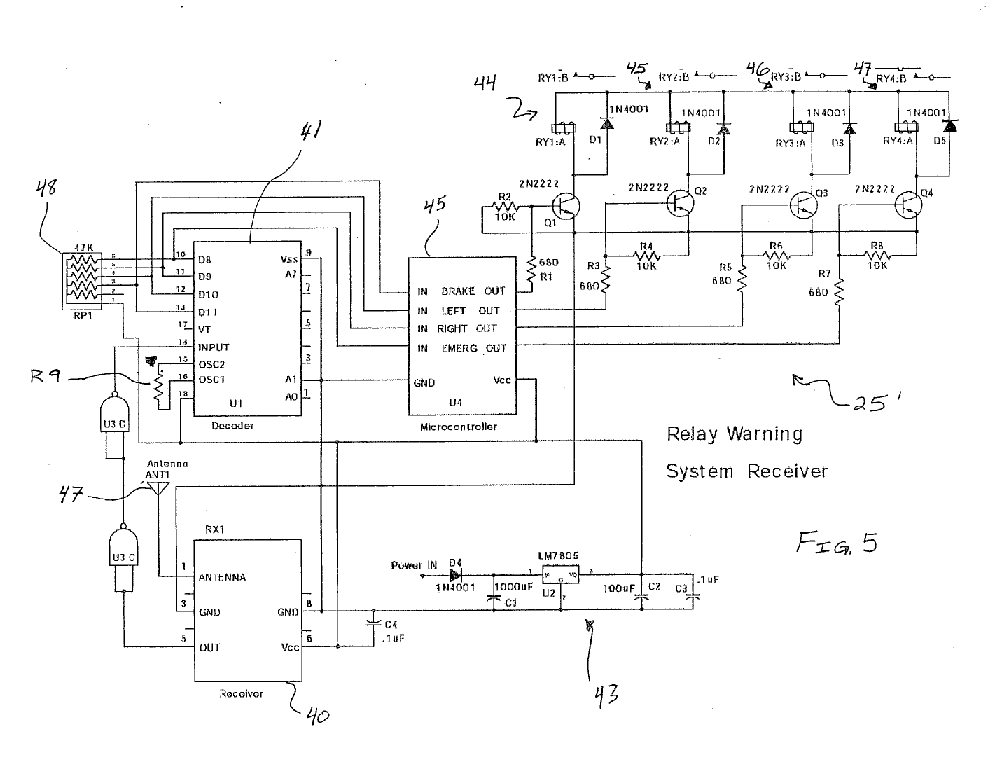

Referring now to FIG. 5, the schematic diagram for a receiver 25′ according to another embodiment is illustrated. Receiver 25′ is similar to receiver 25 in terms of the components and circuitry. In an alternate embodiment of the present invention, receiver 25′ is used in combination with transmitter 24′. In addition to the major components of receiver 25, receiver 25′ has an additional interface circuit 47.

Receipt of a transmitted signal by receiver 25′ is substantially the same as the process described hereinabove for receiver 25.

Table IV provides component information regarding the electrical components that are illustrated and identified in the FIG. 5 receiver 25′ schematic.

TABLE IV

| Component | Additional |
|---|---|
| Symbol | Information |
| U1 | HOLTEK HT 12D |
| U2 | LM 7805 IC |
| U3 | 74 HC00 IC |
| U4 | Microcontroller |
| RX1 | LINX RX 418 RC |
| Q1-Q4 | 2N 3904 or 2N 2222 |
| RY1-RY4 | TX2-5V OMRON relay |
| D1-D5 | 1N4001 |
| R1, R3, R5, R7 | 680 Ohms |
| R2, R4, R6, R8 | 10K Ohms |
| R9 | 180K Ohms |
| C1 | 1000 μF |
| C2 | 100 μF |
| C3 | 0.1 μF |
| C4 | 0.01 μF |
| RP1 | 47K resistor pack |

In a simple implementation, only the brake light signal may be decoded. This would only require the brake interface circuit 44 (Q1, R1, R2, RY1 and diode D1) and would not use the connections to the microcontroller 42 for the right turn interface circuit 46 and left turn interface circuit 45 signals. Power is applied to all of the circuits from the power conditioning circuit 43 including U2, D4, C1, C2 and C3.

However, if a brake signal is received while emergency switch 33 is activated, then the brake light may flash or operate the same as when only a brake signal is received. If the emergency signal is decoded, this would also require the emergency interface circuit 47 including Q4, R7, R8, RY4 and diode D5. Additionally, an emergency indicator may be placed on display panel 50 to indicate the activation of emergency switch 33 of transmitter 34′. In this embodiment (not illustrated), display panel 50 is electrically connected to interface circuits 44, 45, 46 and 47. Alternatively, the brake signal could flash to give a response that will get the driver's attention.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. In combination:
a receiver circuit constructed and arranged to be placed in a first vehicle;
a transmitter circuit constructed and arranged to be placed in a second vehicle, said transmitter circuit operable to generate a signal based on an action by an operator of said second vehicle; and
display means coupled to said receiver circuit and being constructed and arranged to be placed in said first vehicle for alerting an operator of said first vehicle of said action by said operator of said second vehicle, wherein said transmitter circuit signal is received by said receiver circuit.

2. The combination of claim 1 wherein said transmitter circuit signal is the result of a vehicle braking action by the operator of said second vehicle.

3. The combination of claim 1 wherein said transmitter circuit signal is the result of a left turn signal activation by the operator of the second vehicle.

4. The combination of claim 1 wherein said transmitter circuit signal is the result of a right turn signal activation by the operator of the second vehicle.

5. The combination of claim 1 wherein said display means includes a plurality of warning lights.

6. The combination of claim 5 wherein at least one warning light of said plurality of warning lights illuminates in response to a vehicle braiding action by the operator of the second vehicle.

7. The combination of claim 1 wherein said transmitter circuit further includes an emergency switch for generating a stronger signal.
